(19) United States
(12) Patent Application Publication
(10) Pub. No.: US 2012/0241381 A1
(43) Pub. Date: Sep. 27, 2012

(54) Method and apparatus for removal of selenium from water

(76) Inventor: Bruce L. Bruso, Hegins, PA (US)

(21) Appl. No.: 13/424,738

(22) Filed: Mar. 20, 2012

Related U.S. Application Data
(60) Provisional application No. 61/454,772, filed on Mar. 21, 2011.

(51) Int. Cl. C02F 9/04; C02F 1/52; C02F 1/42

(52) U.S. Cl. 210/665; 210/702; 210/705; 210/202

(57) ABSTRACT

A method of treating selenium contaminated water to reduce the concentration of selenium in the water to levels below 5 μg/L uses a first stage treatment by an iron co-precipitation process to remove a bulk concentration of selenium from the water, followed by a second stage treatment wherein the water from the first stage is treated by either a hydride generation process or an ion-exchange media, or a combination thereof, to achieve a selenium concentration level below 5 μg/L.

### CROSS-REFERENCE TO RELATED APPLICATIONS

This application claims the priority of U.S. Provisional Application No. 61/454,772, filed on Mar. 21, 2011.

### BACKGROUND

Federal and State regulations have established increasingly stringent standards for selenium levels in surface water discharges from mining and industrial operations. As reported in the “Review of Available Technologies for the Removal of Selenium from Water” (final report June 2010) to the North American Metals Council, regulations are limiting selenium to levels on the order of 1-5 μg/L in industrial water discharges—levels that are below established safe maximums for potable water. While there are a significant number of proven physical, chemical and biological treatment technologies to remove selenium from water, very few technologies have successfully and/or consistently demonstrated the ability to reduce selenium in water to less than 5 μg/L at any scale, much less in full-scale operation.

Waste rock in the overburden excavated in the mining process is a primary source of selenium in mine drainage water. The selenium is typically present in inorganic forms and leach into run-off water. Steps can be taken to lower selenium levels at the source by reducing contact and dwell time between the waste rock and water, but it is unlikely that any such precautionary measures can effectively limit selenium levels to less than 5 μg/L. Consequently, pre-discharge treatment of the waste water is needed before it can be released into the local watershed.

### BRIEF DESCRIPTION OF THE DRAWINGS

FIG. 1 is a schematic of an exemplary processing plant and method according to aspects of the invention, depicting the flow and treatment of a water stream that contains selenium.

FIG. 2 is a schematic of an alternative embodiment processing plant and method according to aspects of the invention, depicting the flow and treatment of a water stream that contains selenium.

FIG. 3 is an alternative embodiment of stage 2 treatment tanks and method steps of a processing plant of the type shown in FIG. 2.

### BRIEF SUMMARY OF THE INVENTION

The present invention provides methods for the removal of selenium from water, and systems such as a water treatment facility for carrying out those methods.

The methods involve staged treatment of the contaminated water, in which a first selenium removal stage of iron co-precipitation technology is used to remove the bulk of selenium, followed by a polishing stage using a low-concentration selenium removal technology to achieve the final reduction to compliance level. In the preferred embodiments; the polishing stage can be hydride generation gas removal or ion-exchange resins in a metal absorption polymer media, or a combination of hydride generation and ion-exchange resin absorption media.

The systems for carrying out the methods include water treatment facilities with sequential tanks and controls for the selectable applications of the treatment steps within the flow of water through a sequence of the tanks.

The invention is potentially applicable to any discharge stream of water containing selenium, and is particularly suited for the mining industry.

### DETAILED DESCRIPTION

Treatment Methods

The inventive method uses at least a dual-stage selenium reduction process. The first stage of the method is a bulk reduction process using a the known process of ferrihydrite adsorption, commonly referred to as “Iron Co-precipitation” or “Ferrihydrite Co-precipitation”. Ferrihydrite adsorption is a two step physical adsorption process in which a ferric salt is added to the water at proper pH and temperature conditions to form a ferric hydroxide and a ferrihydrite precipitate. A concurrent adsorption of selenium occurs on the surface of the precipitate and thus allows selenium to be removed from the water along with the precipitate; hence the name iron co-precipitation. The term “iron co-precipitation” will be used herein to indicate the process of ferrihydrite adsorption of selenium followed by a removal of the precipitate.

While iron co-precipitation is a low-cost and proven technology, it will not alone achieve the stringent reductions required under present and proposed regulations. The primary limitation on the co-precipitation process is the nature of the selenium in waste rock and, water run-off. Selenium typically occurs in one of four oxidation states: Se(0), Se(−II), Se(VI) and Se(IV). In buried and un-weathered mineral formations, it is most common as elemental selenium Se(0) and selenides such as HSc, which are selenium in the −2 oxidation state, Se(−II). In exposed and weathered waste rock, however, the selenium oxidizes primarily to two oxyanions; selenate (SeO₄)⁻² (which is selenium in the +6 oxidation state, Se(VI)) and selenite (SeO₃)⁻² (which is selenium in the +4 oxidation state, Se(IV)). Se(0) and Se(−II) are insoluble in aqueous solutions and therefore are more likely to be released as fine particulates to the atmosphere, but can be found as colloidal suspensions in run-off surface water. In a relatively neutral pH6 to 8 range, the primary selenium burden in the water column from, for instance, a mine discharge, will be dissolved selenite and selenate, with the possibility of suspended particles of elemental selenium.

The dilemma of iron co-precipitation as a single solution to selenium reduction is that the ferrihydrite precipitate aggressively adsorbs dissolved selenite and suspended selenium particles, but not selenate. This results in a diminishing returns scenario wherein adding more and more ferric salt fails to produce proportional reduction in the selenium level. As reported in a 2001 article, EPA/600/R-01/077 titled “SELENIUM TREATMENT/REMOVAL ALTERNATIVES DEMONSTRATION PROJECT: Mime Waste Technology. Program Activity III, Project 20”, ferrihydrite adsorption was tested by quantity of iron used, in three ranges described as low-iron, medium-iron and high-iron. Significant reduction was noted between low and medium iron (69 μg/L to 42 μg/L), but a much diminished change was observed between medium and high iron (42 μg/L to 35 μg/L). Although the iron co-precipitation was proven effective in reducing selenium to below the 50 μg/L. standard for potable water, it could not achieve levels below 5 μg/L consistently and without consuming excessive quantities of iron.

As a first stage treatment, however, the iron co-precipitation mechanism is a low-cost; effective and predictable process for bulk reduction of selenium. The selenium-bearing precipitate can be separated from the water stream by specific gravity, such as a weir trap, or other such gravity sedimentation filtration, prior to a second stage treatment to reduce the residual selenium concentration to levels below 5 μg/L.

Although ferric chloride is the preferred ferric salt, other compounds such as ferric sulfate can be substituted. The optimum pH range for iron co-precipitation treatment is pH 4 to 6, which is quickly reached when adding ferric chloride. To increase the iron loading, the pH can be maintained in the preferred range by concurrent addition of a non-interfering basic buffer material, such as sodium hydroxide, along with the ferric chloride. The plant systems described hereafter have mixing tanks for ferric salt mixing, and in one embodiment have a subsequent tank for sodium hydroxide/ferric salt mixing if needed to increase iron loading.

Iron co-precipitation is well known and has been designated by the EPA as a Best Available Demonstrated. Technology for selenium removal. However, it will often be incapable of reaching the new lower selenium limits if the water contains a significant fraction of selenate. In such instances, the selenate can be oxidized to selenite by co-mixing with an oxidizing agent such as potassium permanganate. One embodiment of a treatment plant described herein includes a tank for mixing permanganate into the water as the iron co-precipitation process is developing.

Following the addition of the iron salt and sufficient mixing and residence time to allow the breakdown to ferric hydroxide and ferrihydrite, the water is buffered to a pH of 8-9 to make insoluble the ferrihydrite precipitates. A polymer flocculent is then mixed into the water to link the precipitates into larger aggregates that can be separated from the water by gravity or filtration. In the preferred embodiment treatment plants, a floating flocking agent is used to form precipitate agglomerates that are less dense than the water and float to the surface of the water column. This allows the water to flow over a weir chute onto a roller filter, on which the precipitate is filtered out and conveyed to a sludge pan while the water passes trough the filter mesh into a collection tank for further treatment.

The selenium level will be greatly reduced following the stage 1 treatment, and levels below 50 μg/L are routinely achievable, but it may not be reduced to the 1-5 μg/L required by some current regulations, or at least not on a consistent basis over time. In order to consistently reach the reduced levels, the invention uses a second stage polishing process.

One of the presently preferred technologies for second stage processing technology is hydride generation. Hydride generation technology has previously been used in the analytic analysis of trace selenium concentrations. The measurement process, called “hydride generation atomic adsorption spectrometry” (HGAAS), determines trace selenium by generation of its gaseous hydride, hydrogen selenide (H₂Se), using either metallic zinc or sodium borohydride as a reductant. The gaseous hydride is carried out of the liquid by an argon and entrained-air bubbler nozzle and into a hydrogen flame where the atomic fluorescence lines of selenium are detected by an atomic adsorption spectrometer. The attainable detection limits for selenium are 0.3 ng (15 pg/ml) with the zinc reductant and 0.4 ng (20 pg/ml) using the sodium borohydride.

While hydride generation technology is effective to extract a sample to measure for total selenium, it would not be practical as a bulk removal technology for selenium from waste water. As demonstrated herein, however, it is effective as a second stage removal technology where the bulk of selenium has previously been separated from the stream by the first stage iron co-precipitation process.

In one process and plant layout described herein, the water from the first stage collection tank is pumped into a stage 2 holding tank where the pH is adjusted to around 2.0 by adding nitric acid. The high acidity facilitates reaction with borohydride to release hydride gas, and reduces selenate to selenite. The water is then pumped from the holding tank to a bubbling tank through static mixing tubes. Sodium borohydride is injected into the mixing tubes and mixed into the water by the swirling action of the vanes in the tubes. The bubbling tank has air sparger nozzles at the bottom to force compressed air into the water column as a carrier gas to form bubbles that carry the hydride gas to the surface, where it is released.

The hydride generation can be conducted as a continuous process carrying the final traces of selenium off as hydride gas that can be burned for disposal or energy. In one plant embodiment the hydride gas is used in a hydrogen fuel cell to produce electrical power sufficient to run many of the automated functions. The selenium produced at the anode of the fuel cell by the deprotonation of the hydride gas can be captured and refined into an essential nutrient supplement for poultry and other animal feed.

. An alternative polishing stage is to use ion-exchange resins in a metal absorption polymer media as the second stage selenium removal. Iron exchange resin is a media which promotes electrostatic attraction between soluble ions and oppositely charged resin surfaces. In selenium adsorption, the anions selenate and selenite are collected at cationic charged sites in the resin media. A preferred example of such media is the open cell sponge media described in U.S. Pat. Nos. 5,096,946 and 5,002,984, a variation of which is currently sold by Cleanway Environmental Partners under the trade name MetalZorb.

In the water treatment plant systems described herein, the water collected after stage 1 treatment is pumped through an elongated tube or tubes containing a mesh bag filled with the iron exchange sponge material. The open celled sponge provides low impedance to water flow while bringing the water into contact with the resins that absorb both selenate and selenite. Since the bulk of selenium has been removed by stage 1 processing, the sponge material can be used continuously for an extensive time interval before needing replacement.

Description of Plant Layouts.

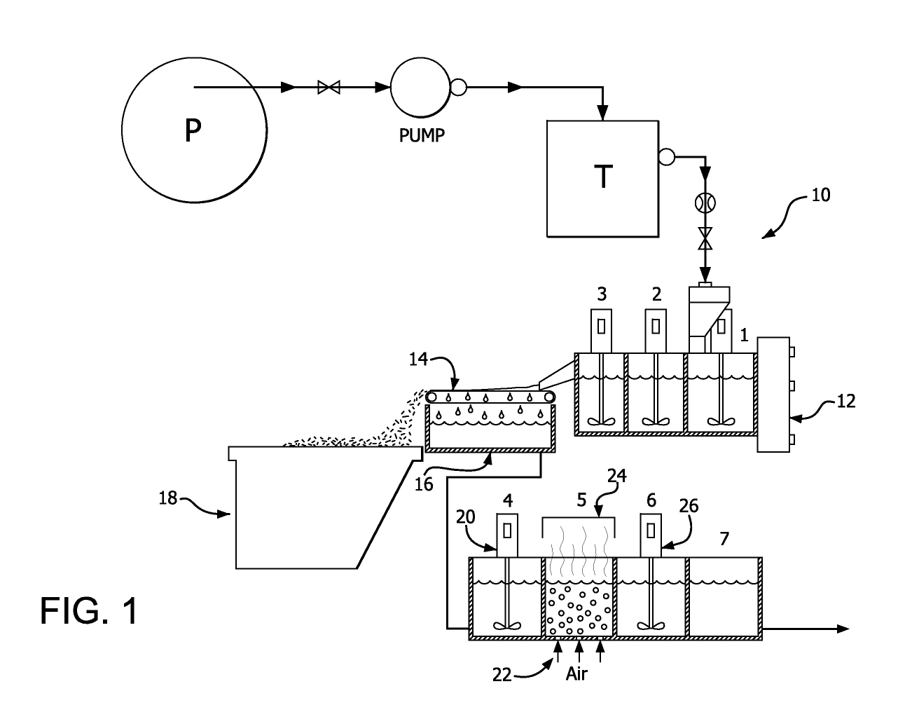

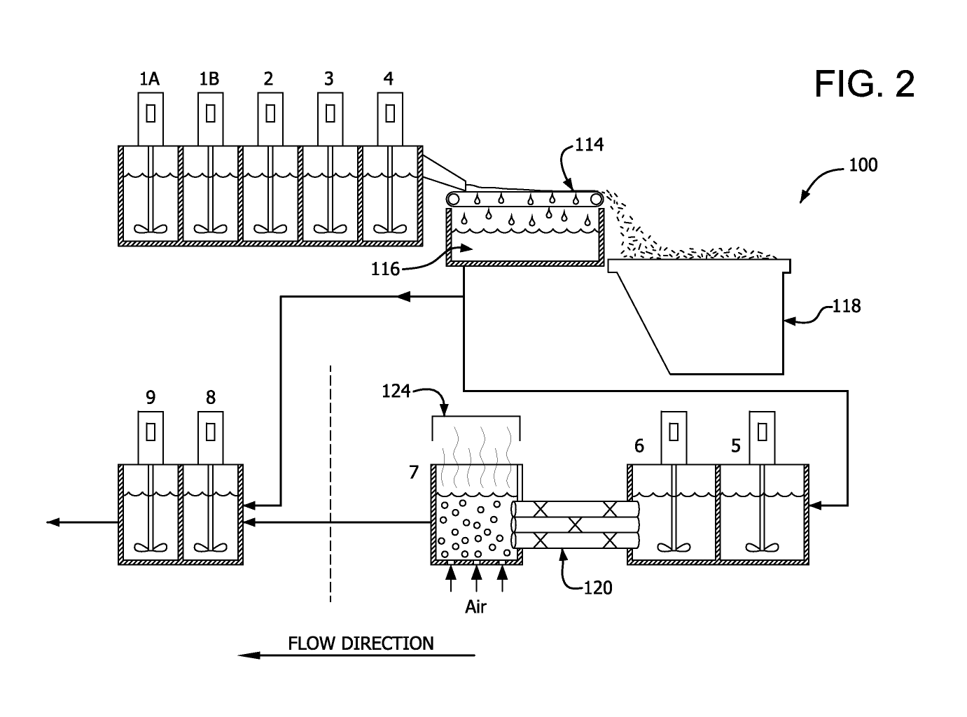

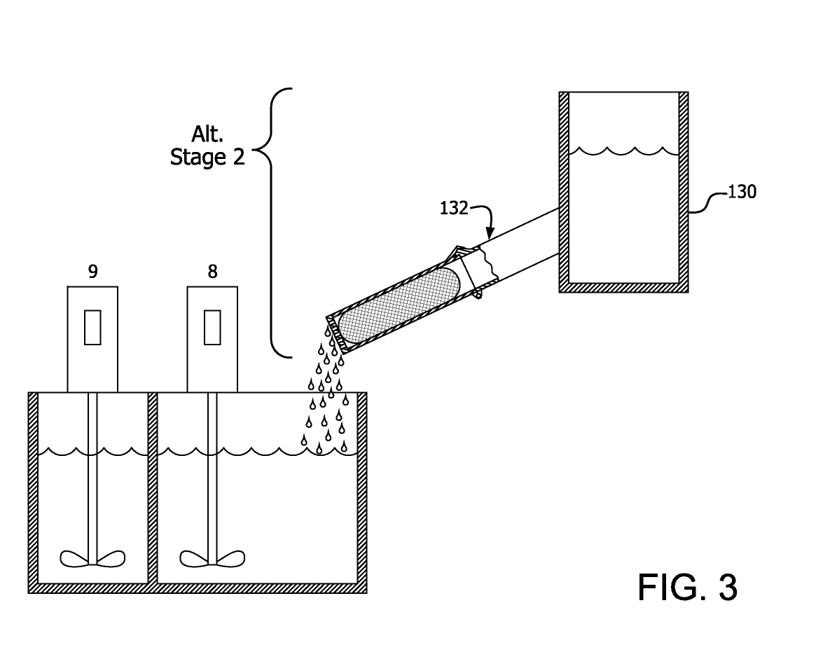

Pilot Plant: FIG. 1 is a schematic representation of a pilot scale processing plant for reducing selenium in waste water, capable of a maximum of 10 gallons per minute, roughly the capacity needed for a small waste water tailing pond. The schematic representation depicts the flow and treatment of the water stream The plant is scalable to larger capacity, although the preference in larger volume plants is to provide more functionality, as described in relation to the larger facility depicted in FIGS. 2 and 3.

A particular feature of the pilot plant layout, however, is that a modular treatment system can be contained in a transportable unit, and several mobile units can be connected in parallel at a particular pond. This gives the operator flexibility to increase or reduce discharge capacity.

In the upper left corner of FIG. 1, an inlet pipe and vacuum pump are used to withdraw waste water from a holding pond P, and into a holding tank T that is mounted on the mobile plant 10. When the holding tank is filled to a desired capacity as detected by a float switch, a metering pump begins to feed the waste water into a first mixing tank 1, where a buffer is introduced to adjust pH. Although the optimal pH for iron co-precipitation treatment is between 4 to 6, this pilot scale process creates a starting solution in tank 1 that is strongly basic by mixing in a sodium hydroxide buffer sufficient to produce a pH 11 to 12 in tank 1. This starting solution allows for greater iron loading as a larger quantity of ferric salt can be introduced in Tank 2 to lower the pH into a preferred range of pH 4-6.

When the desired pH is detected in tank 1, a PLC controller 12 opens a valve to direct flow from tank 1 to the next mixing tank 2, and meters into tank 2 a ferric salt, preferably ferric chloride (FeCl₃), to begin the formation of ferric hydroxide and the ferrihydrite precipitate which adsorbs on its surface dissolved selenite and any suspended selenium particles. The waste water then proceeds from tank 2 to the next mixing tank 3, where a polymer flocking agent is added and mixed throughout the tank to aggregate the precipitates into a floating sludge on the surface of the tank 3.

The outflow from the tank 3 pours onto a sludge belt filter 14 over a water collection trough 16. The belt filter is a wide mesh wire conveyor belt covered with a fine mesh filter cloth that traps the floating precipitate on the belt while allowing the water to pour through into the collection trough. The belt filter conveys the aggregate sludge into a sludge container 18. Water flows out of the collection trough and into tank 4, which is the beginning of the stage 2 treatment process if such additional treatment is required to reduce the residual selenium concentration to the very low 1-5 μg/L range required by some regulations. In this plant layout, the stage 2 processing uses hydride generation technology.

The water in tank 4, at this point, has undergone a bulk selenium removal in stage 1. To begin stage 2, the pH of the water solution is adjusted to an acidic pH within a range of pH 2 to 5, preferable about pH 2, by a chemical feed pump and mixer assembly 20 that controlled by a pH controller (not shown) associated the system PLC 12, that meters in nitric acid. When the pH of the water solution is stabilized at the desired pH, the PLC 12 opens a valve and pumps the adjusted water from tank 4 into a bubbling tank 5. Air injection nozzles 22 in the bottom of tank 5 inject a 12% sodium borohydride solution and pressurized air into the water, causing air bubbles to percolate to the surface. The sodium borohydride reacts with the selenium (and any other reactive metals such as mercury, antimony and arsenic that may be in trace amounts in the water) to form hydride gasses (e.g., hydrogen selenide), which are carried to the surface in the air bubbles. A vacuum hood 24 over the bubbling tank 5 captures the air/hydride stream and carries it out of the water system.

The processed water is then pumped from the bubbling tank 5 into a neutralization mixer tank 6, where another pH adjustment feed pump and controller 26 mix in sufficient buffer to create essentially neutral or slightly basic pure water, which is in turn pumped, into exit tank 7, from which water samples can be taken for compliance testing before the water is be released into a local groundwater drainage or natural stream.

The hydride gas air stream collected by the hood 24 is highly flammable and can be simply burned off into the atmosphere. In a preferred embodiment, however, the gas/air stream is used in a hydrogen fuel cell array (not shown) to produce a low voltage DC current sufficient to power the controls and pumps within the water treatment system. Thus, in a preferred embodiment, the mobile plant further includes a hydrogen fuel cell array fueled, at least in part, by the hydride gas. This embodiment makes the system largely self-contained once it is up and running. Line AC or auxiliary battery power may be needed at start up, and for heavier power demands outside of the system, but the power generated from a fuel cell array should be sufficient for the internal controls and pumps.

The selenium of the hydride gas will be released by a catalyst at the anode of the fuel cells, and only the hydrogen ions will pass through the electrolyte to the cathode. This selenium residue at the anode side is highly concentrated and optionally can be collected and refined into essentially pure elemental selenium that can, for instance, be sold for animal feed supplement.

FIG. 2 depicts the layout and sequence of water flow of a larger scale and more permanent water treatment plant 100 that is capable of processing at least 100 gallons per minute. The stage 1 treatment by iron co-precipitation takes place between treatment tank 1A and tank 4; stage 2 treatment takes place between tanks 5 and 7, and the treated water is buffered and sampled prior to discharge in tanks 8 and 9.

Waste water from an acid mine drainage lagoon is pumped from the lagoon through a pre-treatment filter to remove suspended solid particles that might clog the treatment system 100. The filtered water is directed to tank 1A where it is mixed by a metering and mixing assembly 102 with a ferric salt, preferably ferric chloride, sufficient to lower the pH to an effective range for the breakdown to ferric hydroxide and ferrihydrite, preferably between pH 4.7 to 5.2. In the initial calibration of the plant, the water is allowed to proceed from tank 1A through tank 1B and tank 2 into tank 3, where the flocking agent is added, and then through the roller filter and on to the end of the system at tank 9 where it can be sampled for residual selenium level This initial calibration will give a baseline indication of how much selenium reduction can be achieved through simple iron co-precipitation, as compared to co-precipitation with high iron loading and/or permanganate oxidation. It is unlikely, however, that this baseline, reduction will be sufficient to consistently reach levels below 5 parts per billion. To achieve consistent discharge at these low levels, the process may need to be adjusted for more aggressive co-precipitation and stage 2 polishing.

The first option for increasing the removal through co-precipitation is increase iron loading by adding sodium hydroxide and ferric chloride in tank 1A, as the sodium hydroxide will allow more ferric chloride mixing while staying within the pH 4.7 to 5.2 range. This increased iron loading step should be tried as a first modification to determine what effect it causes in the selenium sampling from tank 9. If the change in selenium reduction is significant, then concurrent use of sodium hydroxide and ferric chloride in tank 1A is worth including in the process, as the additional iron loading yields commensurate reduction in selenium.

The next option to increase co-precipitation is adding an oxidizing agent in tank 1B. The preferred oxidizing agent is potassium permanganate. The purpose, of the permanganate is to convert selenate to selenite before precipitation.

The main formation of ferrihydrite precipitate takes place in tank 2 with the addition and mixing of sodium hydroxide to increase pH to 8 or above. The water from tank 2 flows into tank 3, where the polymer flocking agent is added and mixed through the water column. Tank 4 is the flock development tank, which provides sufficient residence time for the flocking agent to bind the ferrihydrite precipitate into aggregates that float to the surface of the tank.

As in the pilot plant, the surface sludge is separated from the water by pouring onto a roller filter 114 over a collection trough 116. The sludge is conveyed to a sludge container 118. The sludge is a polymer mix with high iron content, and can be de-watered for use in various industrial processes such as smelting

The water in the collection trough 116 can be sent directly to tank 8 for pH neutralization and to tank 9 for sampling to determine the residual level of selenium after the most aggressive iron co-precipitation. If the residual selenium is not consistently below the required level, it will be necessary to use a stage 2 polishing process.

In the layout of FIG. 2, the stage 2 process is hydride generation and removal of residual selenium as a hydride gas. The water from stage 1 collection trough 116 is diverted to stage 2 tanks 5-7. Nitric aid is added in tank 5 to lower the pH, and the water is then pumped into tank 6. The water is allowed to stabilize in tank 6 to a uniform level of around pH 2.0. The stabilized water is then pumped from tank 6 though static mixing pipes 120, where vanes within the pipes cause the water to swirl and mix rapidly. A solution of about 12% sodium borohydride is injected into the static mixing pipes at the inlet from tank 6. When the water exits the static mixers into tank 7, the sodium borohydride is well mixed into the water.

Tank 7 contains the air sparging nozzles from which pressurized air is forced into the bottom of the tank and creates bubbles. The bubbles entrain the selenium hydride and other gases produced by the sodium borohydride, and carry the trapped gases to the surface, where the bubbles burst and release the gases into a vacuum hood 124.

The stage 2 treated water is then sent to tanks 8 and 9 for neutralization, sampling and discharge, as describe before.

FIG. 3 depicts an alternative stage 2 polishing treatment using ion-exchange resins in a metal absorption polymer media as the second stage selenium removal. A preferred example used in the plant layout is an open cell sponge media which is currently sold by Cleanway Environmental Partners under the trade name MetalZorb.

In this alternative plant layout, the water from the stage 1 collection trough 116 is directed to a tank 130 that discharges through one or more elongated vessels 132 that have a hinged opening to insert a mesh bag 134 containing the MetalZorb sponges. The sponge media contains the ion-exchange resins. The open celled sponge provides low impedance to water flow while bringing the water into contact with the resins that absorb both selenate and selenite. Since the bulk of selenium has been removed by stage 1 processing, the sponge material can be used continuously for an extensive time interval before needing replacement. The discharge of the pipe(s) 132 is into the tanks 8 and 9 for neutralization, sampling and discharge, as describe before.

Although not expressly depicted, it should be easily apparent that a treatment plant layout could include both hydride generation and ion-exchange resin systems for stage 2 polishing. The two polishing systems could be run in series, in which the hydride generation discharge passes through the ion-exchange media, or one can be used as a back-up for the other to ensure compliance while one of the systems is shut down for maintenance.

The methods and plant systems described above contain some examples of the invention. The full scope of the invention is described by the claims which follow.

The subject mater claimed is:

1. A method of treating selenium contaminated water to reduce the concentration of selenium in the water to levels below 5 μg/L, the method comprising the steps of treating the water in at least two stages:
(a) wherein a first stage treatment uses an iron co-precipitation process to remove a bulk concentration of selenium from the water,
(b) followed by a second stage treatment wherein the water from the first stage is treated by either a hydride generation process or an ion-exchange media, or a combination thereof, to achieve a selenium concentration level below 5 μg/L.

2. A method as in claim 1, wherein the second stage treatment uses a hydride generation treatment, including the steps of:
(a) adjusting the pH of the water from the first stage treatment to about pH 2, and
(b) mixing sodium borohydride into the water to form hydride gasses including hydrogen selenide),
(c) injecting air into a bottom area of the water to create gas bubbles that percolate to the surface of the water and carry hydrogen selenide out of the water.

3. A method as in claim 2, wherein the second stage treatment includes the additional step of collecting the gasses released from the bubbles with a vacuum collection system.

4. A method as in claim 1, wherein the second stage treatment uses an iron exchange media treatment, including the step of directing the water from the first stage treatment through a vessel packed with an ion-exchange media having an affinity for selenium ions.

5. A method as in claim 2, wherein the second stage hydride generation treatment is followed by an iron exchange media treatment, including the steps of:
(a) adjusting the pH of the water from the second stage hydride generation treatment to about pH 6.5 to 8, followed by:
(b) directing the water through a vessel packed with an ion-exchange media having an affinity for selenium ions.

6. A method as in claim 1, wherein the iron loading of the first stage process is increased by the step of mixing a of a non-interfering basic buffer material into the water along with a ferric salt to maintain a range within pH 4 to 6.

7. A method as in claim 6, wherein the buffer material is sodium hydroxide and the ferric salt is ferric chloride, and the range is pH 4.7 to 5.2.

8. A method as in claim 1, wherein the first stage co-precipitation process includes the step of mixing an oxidizing agent into the water to convert selenate to selenite.

9. A method as in claim 8, wherein the oxidizing agent is potassium permanganate.

10. A treatment system to carry out the method of claim 2, comprising:
(a) a series of treatment tanks to mix a ferric salt into the water to form ferric hydroxide and ferrihydrite precipitates to which selenium attaches, and to mix into the water a flocking agent to aggregate the ferrihydrite precipitates,
(b) a filter to separate the aggregated precipitates from the water, and
(c) a series of tanks to accept the water collected following the first stage filter and to adjust the water from the first stage collection tank to about pH2, and to mix sodium borohydride into the water to form hydride gasses including hydrogen selenide), one of tanks having nozzles for injecting air into a bottom area of the water to create gas bubbles that percolate to the surface of the water and carry hydrogen selenide out of the water.

11. A treatment system to carry out the method of claim 3, comprising:
(a) a series of treatment tanks to mix a ferric salt into the water to form ferric hydroxide and ferrihydrite precipitates to which selenium attaches, and to mix into the water a flocking agent to aggregate the ferrihydrite precipitates,
(b) a filter to separate the aggregated precipitates from water, and
(c) a vessel packed with an ion-exchange media having an affinity for selenium ions.
